(19) United States
(12) Patent Application Publication
(10) Pub. No.: US 2005/0076020 A1
(43) Pub. Date: Apr. 7, 2005

(54) Digital data vending system and method of selling digital data files

(76) Inventors: Jason Huntley, Indianapolis, IN (US); Lance Neubauer, Shoreline, WA (US)

Correspondence Address: Dustin S. DuBois;ICE MILLER, One American Square, Box 82001, Indianapolis, IN, 46282-0200, US

(21) Appl. No.: 10/918,540

(22) Filed: Aug. 13, 2004

Related U.S. Application Data
(60) Provisional application No. 60/495,376, filed on Aug. 15, 2003.

(51) Int. Cl. G06F 17/30

(52) U.S. Cl. 707/3

(57) ABSTRACT

A data file management and vending system includes a plurality of kiosks configured to permit a user to make a data file selection from a collection of such data files and pay for the data file selection, a network operations center including a storage system for storing the collection and at least one server for processing requests for data files and communicating data files to kiosks, and a management system comprising at least a kiosk management system configured to control the flow of data files and to collect information concerning the data files selected. Each of the plurality of kiosks includes a user interface device, a central processing unit, storage, means for transferring the selected data files onto a medium. The network interconnects through links the network operations center, the kiosks, and the management system.

This application claims priority to provisional patent application Ser. No. 60/495,376 filed Aug. 15, 2003.

The present invention relates generally to a digital data vending system and a method of selling digital data files, and more particularly to a digital data file vending system in communication with a communications network configured to retrieve and store and/or report digital data files based on a selection made by a user of the system.

### BACKGROUND AND SUMMARY

One conventional compact disc recorder/vending machine is disclosed in U.S. Pat. No. 5,949,688, issued on Sep. 7, 1999, to Montoya et al. That patent discloses a CD vending system under conventional computer control having one or more microprocessors or central processing units. The system includes, among other things, an ordering screen, a previewing monitor, a keyboard, a payment slot, a viewing window, a dispensing slot and an electric connector for a power supply. In addition, inside the vending system are a data source unit, a CD recording unit, a printing unit for printing indicia on the surface of the CDs and/or packaging.

In one aspect of the invention, a digital file vending device comprises a data file storage device for digitally storing a plurality of data files, a supply of media, means for accessing said plurality of data files and displaying said plurality of data files prior to ordering chosen data selections, means for replicating said chosen data files from said data file storage device on a medium from the supply, means for ordering said chosen data files and transferring said chosen data files from said data file storage device to said means for replicating, at least one external port for downloading said chosen data files from said data storage device to a consumer recording device, and network means for connecting said data storage device to at least one client system.

According to another aspect of the invention, a method for producing a customized removable consumer digital medium comprises the steps of: Reading a set of input parameters via a digital input device on a first terminal; Determining, based on the set of input parameters, a set of files to include on a digital medium; Transmitting a message indicating the set of files from the first terminal to a second terminal via a network; Receiving the message with the second terminal; Reading the set of files from a mass storage device using the second terminal; Writing the set of files to the removable digital medium using the second terminal; and Making the removable digital medium available to a user.

Illustratively according to this aspect, reading a set of input parameters includes displaying options on a touch sensitive video display and reading the input parameters from the touch sensitive video display.

Illustratively according to this aspect, reading a set of input parameters includes displaying options on a video display and reading the input parameters from a pointer device.

Illustratively according to this aspect, reading a set of input parameters includes displaying options on a video display and reading the input parameters from a keypad.

Illustratively according to this aspect, reading a set of input parameters includes displaying options on a video display and reading the input parameters from a keyboard.

Illustratively according to this aspect, the method further comprises providing a graphical database interface via a video display on the first terminal. Additionally illustratively, providing the graphical database interface includes storing a database on the first terminal. Additionally illustratively, providing the graphical database interface includes storing a database on the second terminal. Additionally illustratively, providing the graphical database interface includes storing a database on a remote terminal. Additionally illustratively, providing the graphical database interface includes presenting an option to search by artist, album, and track.

Illustratively, according to this aspect of the invention, providing the graphical database interface includes displaying an image of an album and a list of tracks on the album.

Illustratively, according to this aspect of the invention, transmitting the message includes transmitting the message over a local area network coupled between the first terminal and the second terminal. Additionally illustratively, transmitting the message over the local area network includes transmitting the message over a wireless local area network.

Illustratively, according to this aspect of the invention, reading the set of files from a mass storage device includes reading the set of files from a hard disk drive internal to the second terminal.

Illustratively, according to this aspect of the invention, reading the set of files from a mass storage device includes reading the set of files from a hard disk connected external to the second terminal.

Illustratively, according to this aspect of the invention, the method further comprises generating a machine readable token with the first terminal, making the machine readable token available to the user, and making the removable digital media device available to the user after the second terminal has read the machine readable token. Additionally illustratively, the machine readable token is a paper with a bar code. Additionally illustratively, the machine readable token is punch card. Additionally illustratively, the machine readable token is card having a magnetic strip. Additionally illustratively, the machine readable token is card smart card.

Illustratively, according to this aspect of the invention, the method further comprises reading a credit card with the first terminal, and making the removable digital media device available to the user after the second terminal has read the credit card.

Illustratively, according to this aspect of the invention, the method further comprises accepting a payment from the user. Additionally illustratively, accepting a payment from the user includes reading a credit card with the first terminal. Additionally illustratively, accepting a payment from the user includes providing access to an electronic payment service via the first terminal. Additionally illustratively, accepting a payment from the user includes accepting currency. Additionally illustratively, accepting a payment from the user includes accepting a card having a first information stored thereon relating to the available credit the user, reading the first information, and writing a second information to the card.

According to another aspect of the invention, a data file management and vending system comprises a plurality of kiosks configured to permit a user to make a data file selection from a collection of such data files and pay for the data file selection; a network operations center including a storage system for storing the collection and at least one server for processing requests for data files and communicating data files to kiosks; a management system comprising at least a kiosk management system configured to control the flow of data files and to collect information concerning the data files selected. Each of the plurality of kiosks includes a user interface device, a central processing unit, storage, means for transferring the selected data files onto a medium. A network interconnects through links the network operations center, the kiosks, and the management system.

Illustratively, according to this aspect of the invention, at least one kiosk includes a plurality of user interface devices and a plurality of payment receivers coupled to the central processing unit so that a plurality of users can make different data file selections, and pay for the user's selections. Additionally illustratively, the at least one kiosk includes a burning station coupled to the network, and spaced apart from at least one of the payment receivers and at least one of the user interface devices, the burning station configured to receive a ticket from a user to identify the user's data file selection and transfer the data files.

Illustratively, according to this aspect of the invention, the user interface device is a touchscreen that displays information to the user and receives inputs from the user.

Illustratively, according to this aspect of the invention, the means for transferring the selected data files onto a medium includes a compact disc burner. Additionally illustratively, the means for transferring the selected data files onto a medium includes a port configured to permit attachment of a user's recordable medium and to permit transfer therethrough of the selected data files to the medium.

Illustratively, according to this aspect of the invention, the data files are stored on the storage of each kiosk, and one of the central processing unit or the network operations center or the management system includes instructions to retain only the most frequently selected data files based on a predetermined criteria, and if a data file meets the criteria, the data file is retained in the storage, and if a data file does not meet the criteria the data file is removed from storage.

Additionally illustratively, the instructions to retain only the most frequently selected data files based on a predetermined criteria include information concerning the frequency of selection of data files for each kiosk independently, such information forms the criteria for that kiosk, and if a data file does not meet the criteria for that kiosk the data file is removed from storage.

### BRIEF DESCRIPTION OF THE DRAWINGS

The detailed description particularly refers to the accompanying figures in which:

FIG. 1 is a system level block diagram of a data file vending system;

FIG. 2 is a diagrammatic representation of the data file vending system of FIG. 1;

FIG. 3 is a block diagram of a kiosk associated with the data file vending system;

FIG. 4 is a detailed block diagram of the kiosk of FIG. 3;

FIG. 5 is a flowchart of a method of producing a customized medium;

FIGS. 6a through c are screenshots of the kiosk software graphical user interface (GUI);

FIG. 6a is a screenshot of the kiosk software showing an introductory search screen;

FIG. 6b is a screenshot of the kiosk software showing a current track listing;

FIG. 6c is a screenshot of the kiosk software showing a keyboard search screen to permit a user to enter text and numerical characters;

### DESCRIPTION OF THE PREFERRED EMBODIMENTS

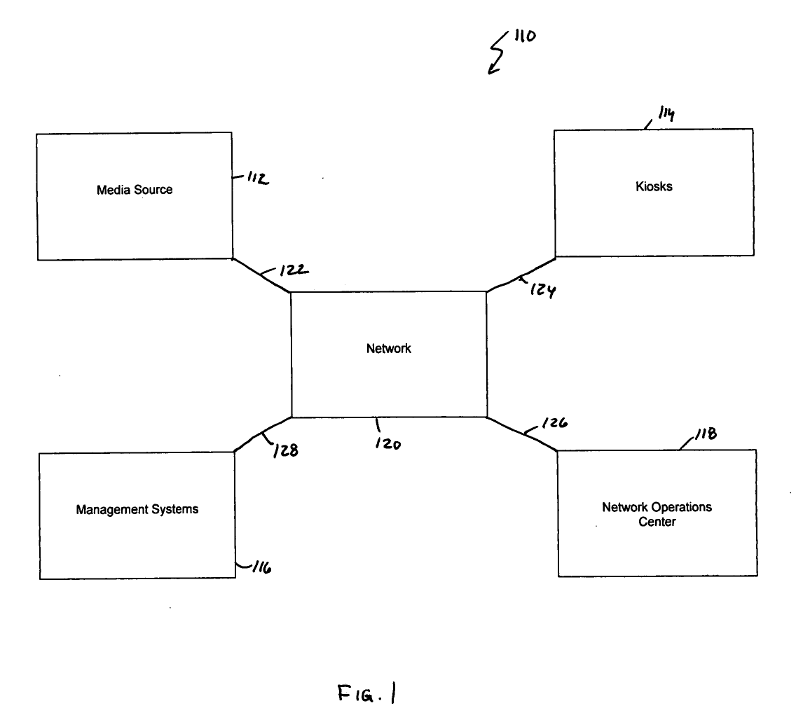

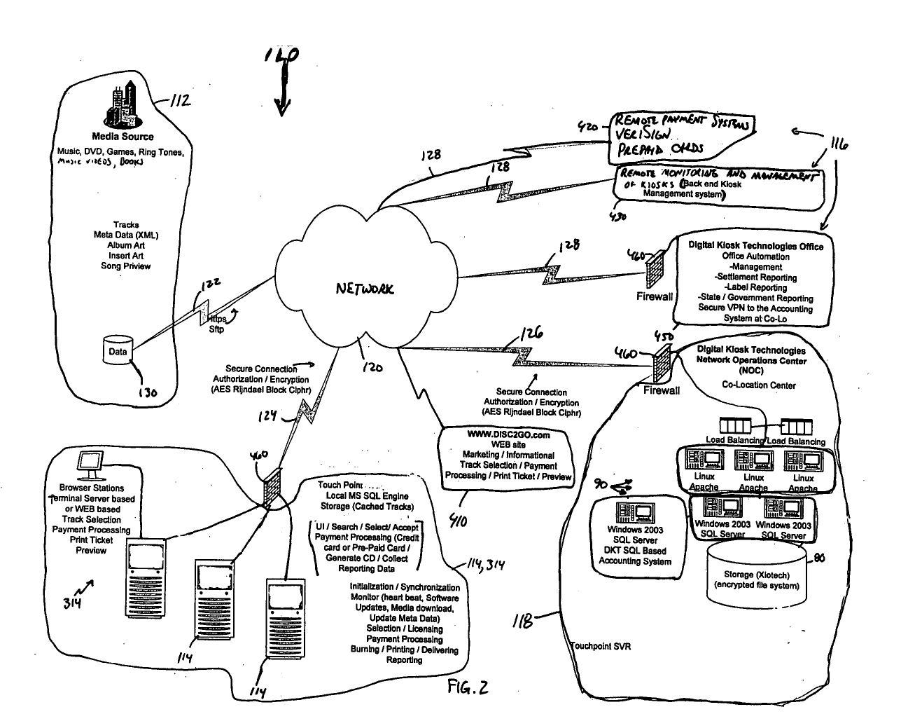

FIG. 1 illustrates a block diagram of a data file management system 110. A media source 112, kiosks 114, a management system 116, and a network operations center 118 are coupled by a network 120 to permit interaction among the various systems of data file management system 110.

Media source 112 is a source of data files, preferably digital data files, and illustratively includes sources of music, movies, games, ring tones, books in written or audio format, and the like, in the form of data files. Media source 112 may be connected to network 120 by a communication link 122 for transferring data files over network 120. Alternatively, digital files may be transferred using other methods such as shipping media on which data files are stored, such media including compact discs, DVDs, minidisks, solid state memory, hard drive disks, and the like.

Each of a plurality of kiosks 114 includes a user interface that permits the user to select one or more data files, pay for his/her selection, and receive the file in a suitable format. Kiosks are also coupled by a link 124 to network 120 to other parts of data file management system 110. Link 124 permits transfer of data files and information relating to payment, sales, and management of the data file management system 110, as described in detail below.

Network operations center 118 includes storage 80 for data files and one or more servers 90 to communicate with kiosks 114, management system 116, other parts of network operations center 118, and other parts of data file management system 110, and to host website 410. Network operations center 118 is also coupled through network 120 by a link 126 to other parts of data file management system 110. Network operations center 118 is illustratively a co-location that permits only secure entry of authorized personnel.

Management systems 116 illustratively include kiosk management systems, payment systems, and office management systems to permit management of kiosk operations, payment methods, and various reporting, tracking, and other office management activities. Management systems 116 is also coupled through network 120 by a link 128 to other parts of data file management system 110.

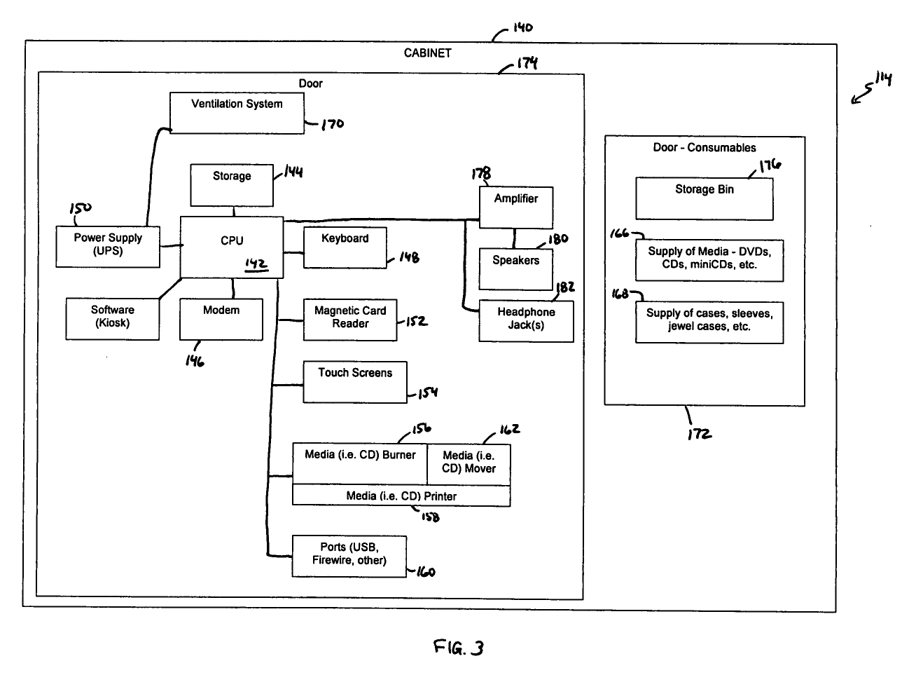

Network 120 may be a global network, such as the Internet, a wide area network (WAN), or a local area network (LAN). The network 120 may include wireless communication networks, local area networks (LAN), wide area networks (WAN), satellite networks, Bluetooth networks, or other types of networks. Although elements of the network 120 are shown as directly coupled in FIGS. 1 and 2, the elements may be indirectly coupled and separated geographically. The simplified coupling is shown in order to more clearly illustrate communication paths.

Referring now to FIG. 2, media source 112 is illustratively a plurality of different sources of different types of data files 130. For example, music labels, motion picture studios, video game producers and the like can supply data files 130 to be used with data file management system 110. In addition to data files 130 such as music tracks, motion pictures, music videos, games, ring tones and books, other data files 130 may be included for use in data file management system 110, including but not limited to album art, insert art, book and jacket cover illustrations, song previews, meta data (containing information about the other data files), and the like.

Referring still to FIG. 2, data files 130 may be encrypted and/or compressed using any suitable form of encryption and/or compression. Link 122 connects media source 112 to other parts of data file management system 110 through network 120. Media sources 112 send data files illustratively through link 122, using any suitable communication protocol. One example of such a protocol is secure sockets layer (SSL), a protocol developed for transmitting private documents via the Internet. SSL works by using a private key to encrypt data transferred over the SSL connection. Another example of such a protocol for transmitting data securely over the World Wide Web is Secure HTTP (S-HTTP). Whereas SSL creates a secure connection between a client and a server, over which any amount of data can be sent securely, S-HTTP is designed to transmit individual messages securely. Another example is SFTP (SSH (Secure SHell) File Transfer Protocol). It is within the scope of this disclosure to utilize other ways of transferring data files 130 to data file management system 110, including but not limited to saving data files 130 onto a suitable storage medium and manually transferring the saved files into system 110.

FIG. 2 illustrates kiosks 114, 314. As explained in more detail below, kiosks 114, 314 can take several forms.

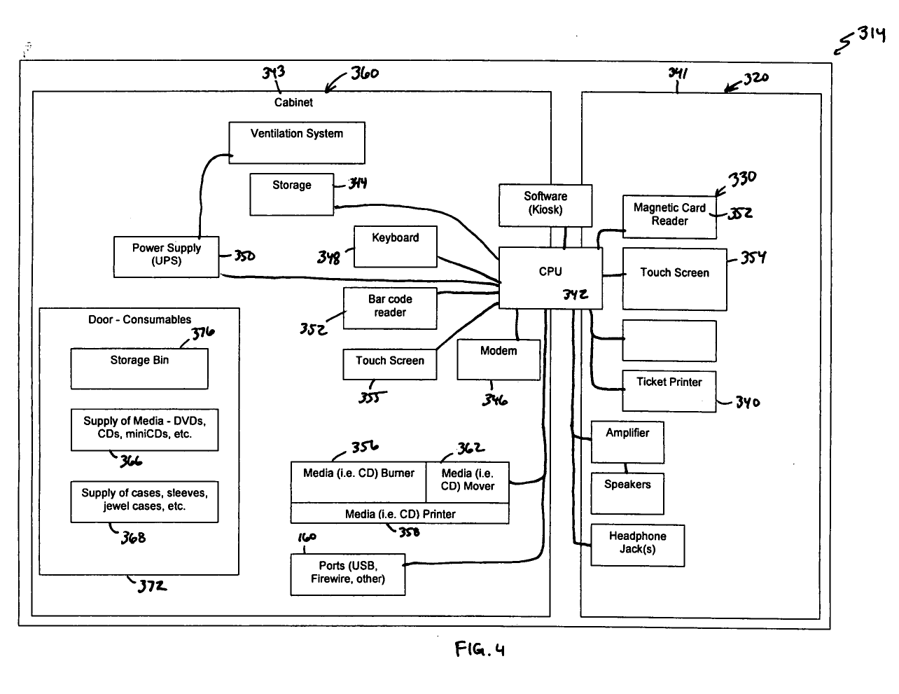

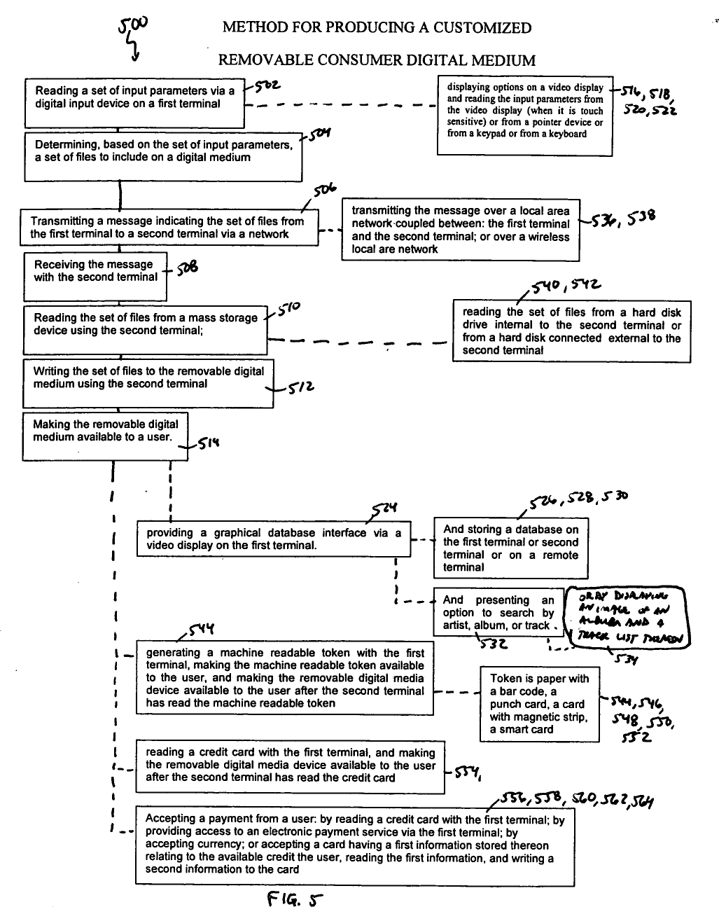

As shown in FIG. 3, kiosk 114, one typical kiosk used in data file management system 110, includes a cabinet 140 that houses a central processing unit (CPU) 142, a hard disk 144 for storage of data files 130, a modem 146, a keyboard 148, a power supply—illustratively an uninterrupted power supply (UPS) 150, a magnetic card reader 152, a user interface device such as a touch screen 154, a CD burner 156, a printer 158, ports 160, a CD (or other media) mover 162, a supply 166 of recordable media such as CDs, mini CDs, and DVDs, a supply of covers 168 such as jewel cases, cases, sleeves, and the like, and a ventilation system 170.

Referring again to FIG. 3 cabinet 140 illustratively includes a first door 172 and a second door 174. First door 172 provides access to consumables such as supplies 166, 168. First door 172 is locked with a lock (not shown) that is un-lockable with a first key (not shown) possessed by a person, for example, who works in the facility in which kiosk 114 is located. Second door 174 is locked with a lock (not shown) that is un-lockable with a second key (not shown) different from the first key. Second key is possessed by a person having the authority to open cabinet 140 to gain access to the non-consumables such as CPU 142, keyboard 148, UPS 150, and other parts inside cabinet 140 for purposes of maintenance, reprogramming, and the like. In one embodiment, kiosk 114 includes a storage bin 176 in which are inserted a supply of sleeves for storing the media on which the digital files are stored. FIG. 3 illustrates an amplifier 178, speakers 180, and headphone jack(s) 182 interconnected to permit a user to preview songs or other data files prior to choosing or purchasing the data file.

In another embodiment, kiosk 114 includes multiples of certain of the aforementioned components. For example, to permit multiple users to browse through available data files 130, multiple user interface devices such as touch screen 154 may be included. Multiple CPUs 142 may be connected, such as one CPU for each touch screen 154, each CPU may be coupled to storage 144. Multiple CD burners 156, media movers 162 and printers 158, magnetic card readers 152 or other payment systems, and ports 160 may also be included. Likewise, multiple supplies 166 of recordable media such as CDs, mini CDs, and DVDs, and multiple supplies of covers 168 such as jewel cases, cases, sleeves, and the like, may be provided.

The components of kiosk 114 may take on a variety of different configurations and one or more of the components may be omitted within the scope and spirit of this disclosure. The following is a listing of exemplary components and is provided for illustrative purposes only. CPU 142 is a Cybertron 2U Rackmount with 2.8 GHz Pentium 4 processor, Dual 200 GB hard drives (storage 144) mirrored, 512 MB Memory, RAID configuration, 10/100 network card, CD-ROM and Floppy drives, available from Cybertron International, Inc., 1122 E. Osie St., Wichita Kans. 67211. Keyboard 148 is a standard English qwerty touchpad keyboard. UPS 150 is a Tripp Lite SmartPro 3000RM2U and includes PowerAlert UPS Management Software, both available from Tripp Lite, located at 1111 W. 35th Street, Chicago, Ill. 60609. Touchscreen 154 is a 15 inch 3M Microtouch Chassistouch FPD Flat Panel Display available from 3M Touch Systems Inc., a subsidiary of 3M, headquartered in St. Paul, Minn. Amplifier 178 is a Peavey rack mount amplifier available through Peavey Electronics Corporation, 711 A Street, Meridian, Miss. 39301. Speakers 180 are Power Acoustik 110 watt, 4 inch, 2-way speakers available through Power Acoustik Electronics, 1550 S. Maple Ave. Montebello, Calif. 90640.

In one embodiment, kiosk 114 is a stand-alone model which interacts with a user to permit the user to pay, select one or more data files, acquire the data file, and copy the data file to a recordable medium.

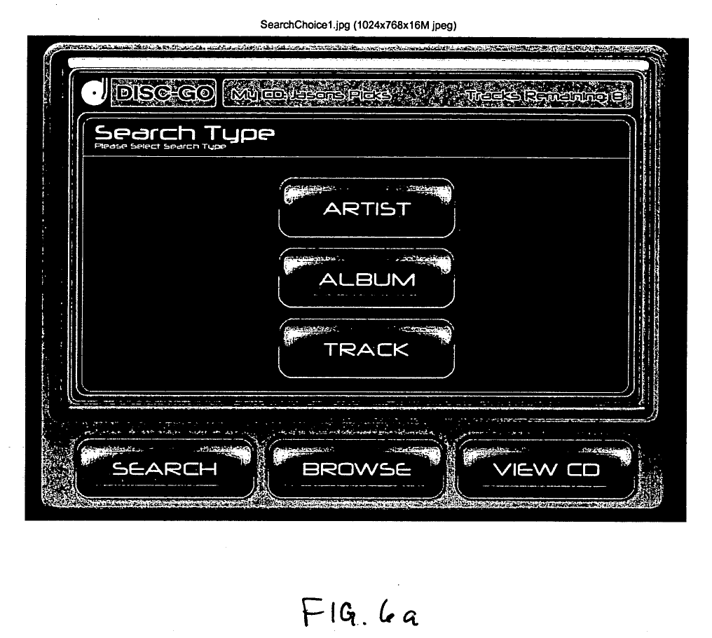

In another embodiment, kiosk 314 is made up of multiple separate components. FIG. 4 illustrates kiosk 314, which includes browsing station(s) 320, payment systems 330, and ticket station 340, which permit a user to pay, select, and acquire a ticket for a separate burning station 360.

Browsing station 320 includes payment system 330 illustrated as a magnetic card reader and/or writer. Payment system 330 could include any one or combination of such a magnetic card reader/writer and currency validator/acceptor, cellular telephone payment/communications means, and the like. Payment system 330 could take the form of a software routine that is in communication with a cash register or other payment system in the facility in which browsing station 320 is located, to indicate when the particular user using the browsing station has paid for the present service at such cash register or other payment system. Payment system 330 could take the form of a software routine that is in communication with an offsite payment solution such as PayPal.

Browsing station 320 further includes a central processing unit (CPU) 342, a hard disk 344 for storage of data files, a keyboard 148, payment system 330 such as a magnetic card reader 352, a user interface device such as a touch screen 354, a ticket or receipt printer 340. Referring again to FIG. 4, a cabinet 341 encloses and/or retains browsing station 320 components and, illustratively, includes a door that provides access to consumables such as paper for ticket printer 340. Browsing station, as illustrated in FIG. 4, includes an amplifier 378, speakers 380, and headphone jack(s) 382 interconnected to permit a user to preview songs or other data files prior to choosing or purchasing the data file.

A plurality of browsing stations 320 can be provided in one facility to permit a like number of users to browse through data files and enter selections on a play list. The play list is sent, either as it is developed by a user or after it is fully developed, to a burning station 360. The user proceeds to burning station 360 to have the user's play list burned or recorded onto a suitable storage medium.

Burning station 360, as illustrated in FIG. 4, includes a cabinet 343 that houses a central processing unit (CPU) 342, a hard disk 344 for storage of data files 130, a modem 346, a keyboard 348, a power supply—illustratively an uninterrupted power supply (UPS) 350, a bar code reader 352, a user interface device such as a touch screen 355, a CD burner 356, a printer 358, ports 360, a CD (or other media) mover 362, a supply 366 of recordable media such as CDs, mini CDs, and DVDs, a supply of covers 368 such as jewel cases, cases, sleeves, and the like, and a ventilation system 370.

CPU 342 may be associated with burning station 360 only or it may be also associated with one or more browsing stations 320. In one example, CPU 342 may run software that permits a user to browse through the songs that are currently available at the same time, for a different user, CPU 342 is requesting songs on that different user's play list from a remote server to be sent via a network connection to CPU 342 and CPU 342 may then instruct media burner 356 to retrieve a CD from supply 166 and start recording the selections thereon.

Referring again to FIG. 4, cabinet 343 illustratively includes a first door 372 and a second door (not shown). First door 372 provides access to consumables such as supplies 366, 368. First door 372 is locked with a lock (not shown) that is un-lockable with a first key (not shown) possessed by a person, for example, who works in the facility in which burning station 360 is located. The second door is locked with a lock (not shown) that is un-lockable with a second key (not shown) different from the first key. Second key is possessed by a person having the authority to open cabinet 343 to gain access to the non-consumables such as CPU 342, keyboard 348, UPS 350, and other parts that may be inside cabinet 343, for purposes of maintenance, reprogramming, updates, and the like. In one embodiment, burning station 360 includes a storage bin 376 in which are inserted a supply of sleeves for storing the media on which the digital files are stored.

In another embodiment as suggested in FIG. 2, browsing software or functionality is provided via a website 410 available through the Internet or similar communications network. Similar functionality to the browsing performed at browsing stations and kiosks described above exists for users at the website.

A user accesses the website and indicates his desire to create a play list. The user browses data files using one or more of the above described browsing techniques. Optionally, the user can preview the data files. The user selects data files and adds the selected files to the user's play list until the user indicates that he has completed his selections, until a predetermined limit is reached, or until no further available recordable space is available on the medium selected. The play list information includes data file identifiers, which data file identifiers are saved in association with a user identifier that is unique to the user and that is saved to a central storage location for future retrieval. A ticket is printed for the user to take with him to a kiosk 114, 115 or a burning station 360.

The user provides the ticket to the kiosk to permit the kiosk to process the ticket—for example the ticket may include a bar code which corresponds to the user identifier, that is read by a bar code reader of burning station 360 or kiosk 114, 115. Alternatively, the user may be provided a code or other user identifier that can be input to the burning station 360 or the kiosk 114, 115 using the user interface device 154. Burning station 360 or the kiosk 114, 115 then compares the user identifier to those stored in the central storage location to determine the user identifier's authenticity and to retrieve the play list. The play list information data file identifiers are then processed by the software and the data files are transferred as necessary and recorded onto the proper media. As necessary, the media is delivered to the user. The transaction may be registered as completed by storing a value with the user identifier.

As introduced above, management systems 116 illustratively include payment systems, kiosk management systems, and office management systems to permit management of kiosk operations, payment and payment tracking, accounting, and various reporting, tracking, and other office management activities. Management systems 116 is coupled through network 120 by a link 128 to other parts of data file management system 110.

Management systems 116 includes remote payment systems 420. Remote payment systems 420 may utilize an Internet-based system such as VeriSign, in the case of kiosks, a point-of-sale system may be implemented. The point-of-sale system includes terminals and applications that plug directly into a DSL, cable, or other high-speed connection. Each time a credit card is swiped, the transaction is routed immediately over Internet Protocol (IP) to VeriSign, for processing to the financial networks. In the case of payment at website 410, the Payflow Pro product available through VeriSign can accept credit cards, purchase cards of different levels (for supported processors) and electronic checks online. Payflow Pro will permit processing of orders received offline via telephone, fax, e-mail or in person.

Kiosk management systems 430 permit the remote monitoring and management of kiosks 114, 314 and other parts of data file management system 110. For example, all information relating to tasks the kiosks have performed can be accessed at the kiosks using Kiosk management systems 430. Other possible fluctions include, but are not limited to initialization of kiosks, synchronization of kiosks with other parts of data file management system 110, detection of heartbeat, delivery and checks of software updates, media downloading, meta data updating, selections made information gathering, licensing information delivery, payment processing information management and gathering, and management of the processes and/or information relating to burning (transferring or copying data files 130 to media), printing (including printing difficulties, ink supply, and the like), delivery of and onto media, and reporting of all information stored on kiosks 114, 314 and relating to the operation of and failures in connection with the operation of kiosks 114, 314.

Network operations center 118, as explained in brief above, includes storage system 80, illustratively a storage system such as the Magnitude storage system available through Xiotech Corporation 6455 Flying Cloud Drive Eden Prairie, Minn. 55344. Further, multiple servers are provided including Apache web servers running a Linux operating system, SQL kiosk servers running a Windows 2003 operating system, and a dedicated SQL accounting system server with a Windows 2003 operating system and with a secure virtual private network connection to office management system 450, detailed below.

TouchPoint CatapultSVR is a web-based suite of tools that serves as an example of one possible kiosk management system. CatapultSVR provides centralized, secure remote management of networks, devices and syndicated digital content. CatapultSVR maximizes operational efficiency by streamlining the content management and distribution processes. CatapultSVR is available from, in the United States, TouchPoint Solutions U.S.A. 12480 West Atlantic Blvd, Suite 2, Coral Springs, Fla. 33071, or in Canada through Touchpoint Solutions, Inc. 5180 Orbitor Drive, Toronto, Ontario. Catapult SVR may be provided in cooperation with network operation center 118, kiosks 114, 314, kiosk management system 430, and office management system 450 to permit interaction, control, and controllable communication among the various components of data file management system 410.

Office management systems 450 includes software that cooperates with other parts of data file management system 110 to perform functions such as, but not limited to remote management of kiosks, the network operations center, and the kiosk management system, settlement reporting, reporting to media sources 112, required governmental entity reporting and automation of these and other functions. Illustratively, a secure virtual private network (VPN) to the accounting system at network operations center 118.

Illustratively, to enhance security of data file management system 110, firewalls 460 are provided between office management system 450 and link 128, between network operations center 118 and link 126, and between kiosks 114, 314 and link 124.

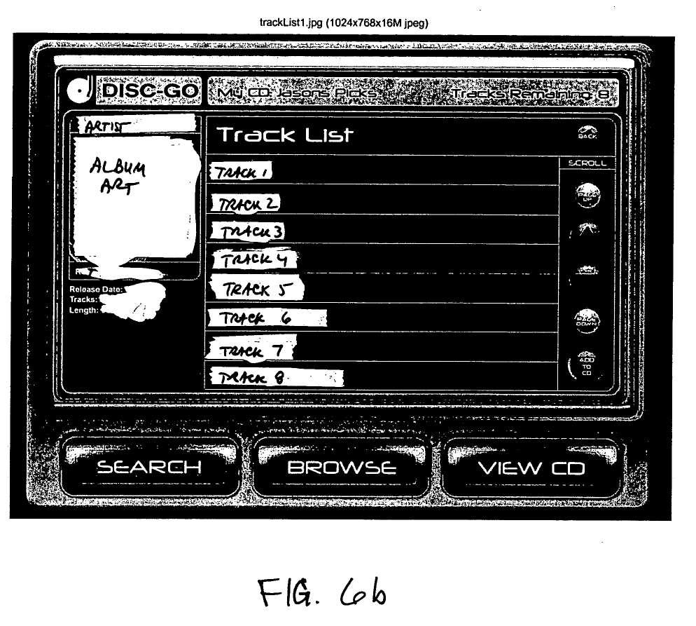

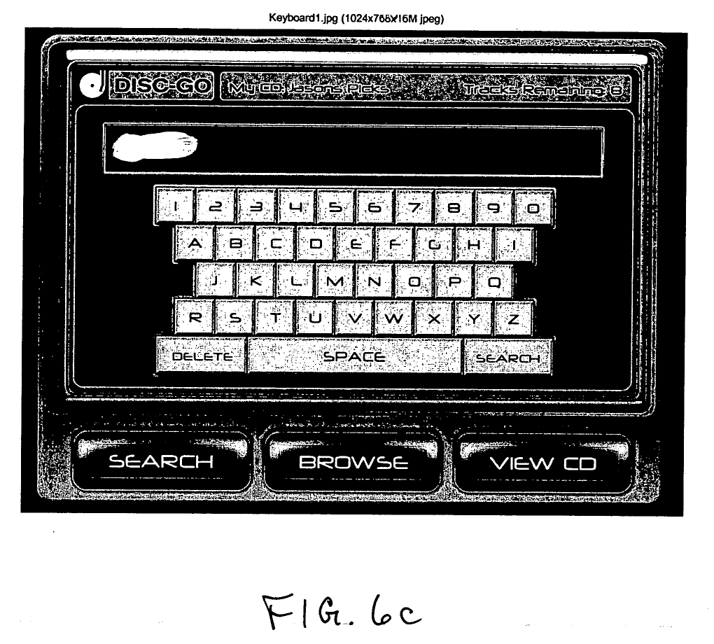

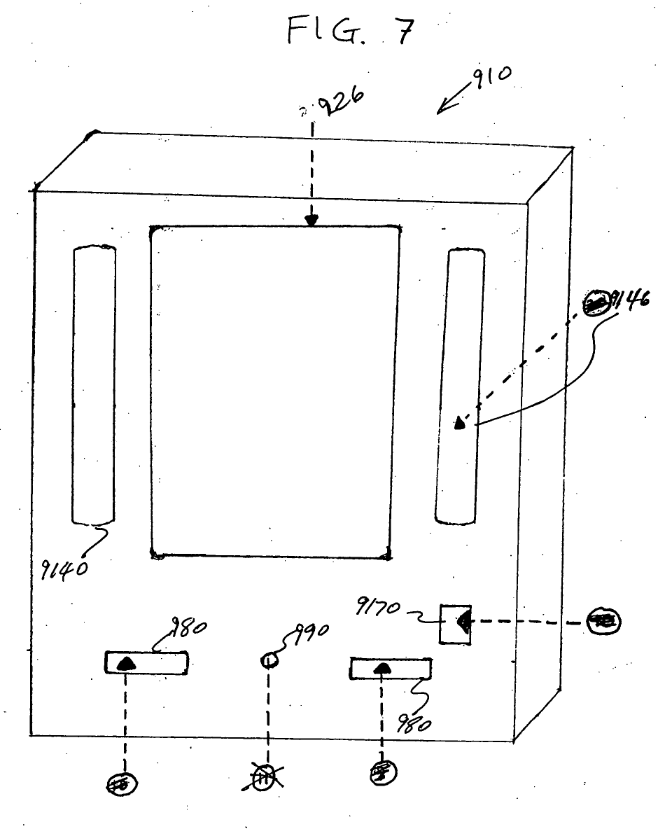

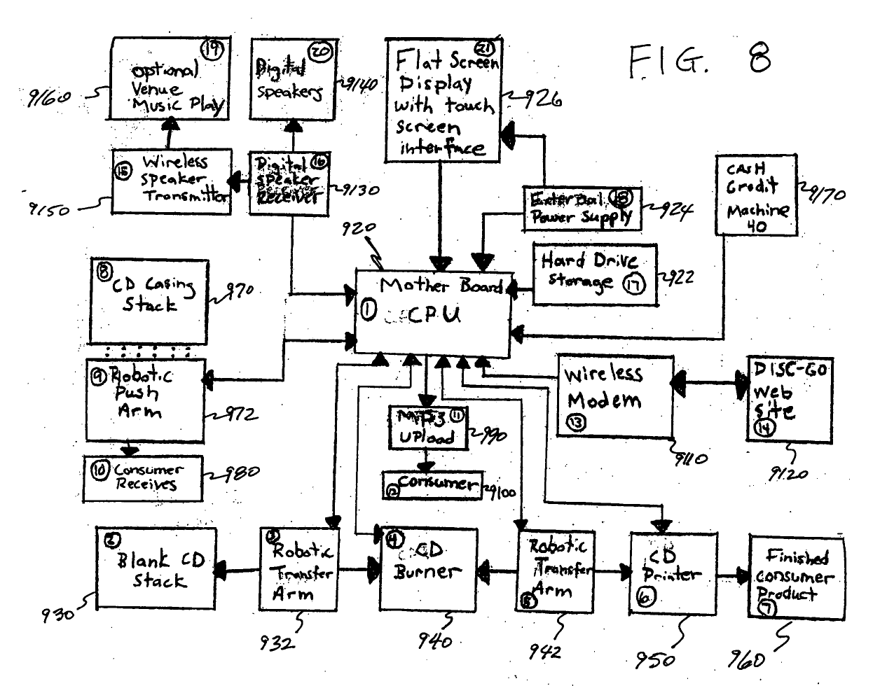

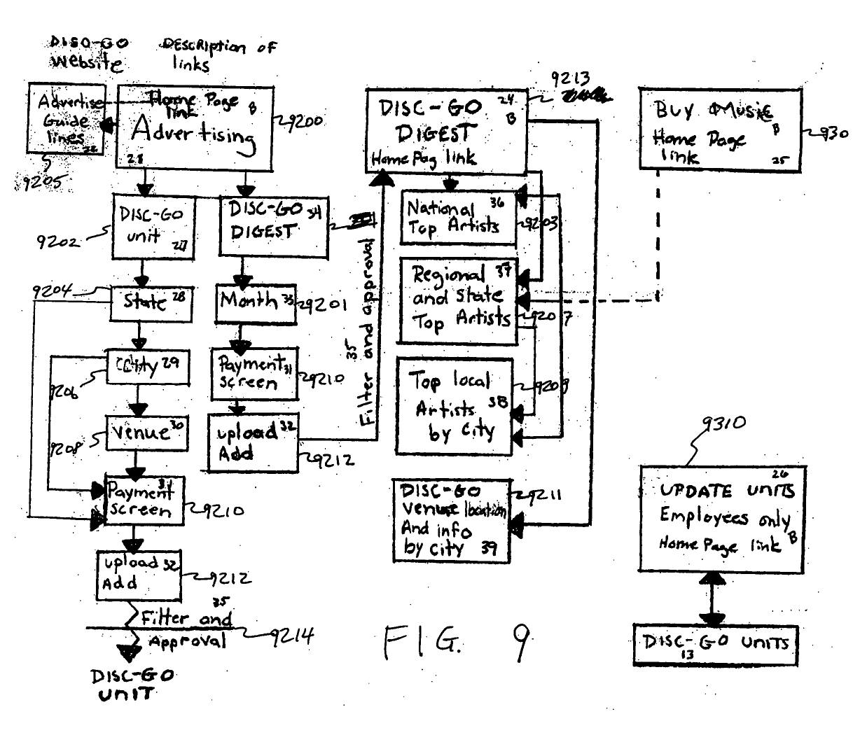

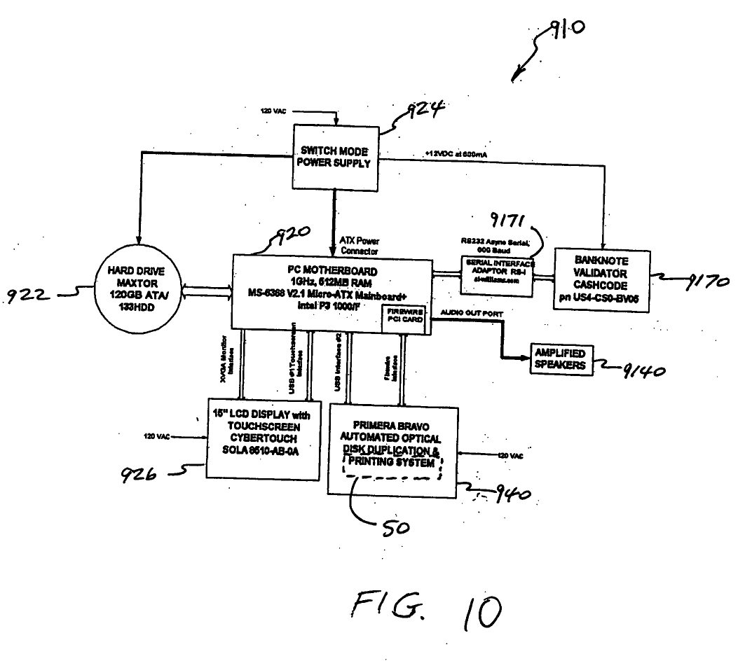

FIG. 5 illustrates a method 500 of producing a customized, removable consumer digital medium will now be described, with optional steps shown using dashed lines. Method 500 for producing a customized removable consumer digital medium, comprises the steps of: reading a set of input parameters via a digital input device on a first terminal (502); determining, based on the set of input parameters, a set of files to include on a digital medium (504); transmitting a message indicating the set of files from the first terminal to a second terminal via a network (506); receiving the message with the second terminal (508); reading the set of files from a mass storage device using the second terminal (510); writing the set of files to the removable digital medium using the second terminal (512); and making the removable digital medium available to a user (514).

As used in this description, album means a collection of audio, video, or other multimedia files, irrespective of whether the files have ever been published as a compilation in physical form.

The method may also include displaying options on a touch sensitive video display and reading the input parameters from the touch sensitive video display (516). The method may also include displaying options on a video display and reading the input parameters from a pointer device (518). The method may also include displaying options on a video display and reading the input parameters from a keypad (520). The method may also include displaying options on a video display and reading the input parameters from a keyboard (522).

The method may also comprise providing a graphical database interface via a video display on the first terminal (524). Providing the graphical database interface may include storing a database on the first terminal (52.6). Providing the graphical database interface may include storing a database on the second terminal (528). Providing the graphical database interface may include storing a database on a remote terminal (530). Providing the graphical database interface may include presenting an option to search by artist, album, and track (532). Providing the graphical database interface may include displaying an image of an album and a list of tracks on the album (534).

In this method, transmitting the message may include transmitting the message over a local area network coupled between the first terminal and the second terminal (536). Further, transmitting the message over the local area network may include transmitting the message over a wireless local area network (538).

In this method, reading the set of files from a mass storage device may include reading the set of files from a hard disk drive internal to the second terminal (540). In this method, reading the set of files from a mass storage device may include reading the set of files from a hard disk connected external to the second terminal (542).

This method may further comprise generating a machine readable token or ticket with the first terminal, making the machine readable ticket available to the user, and making the removable digital media device available to the user after the second terminal has read the machine readable token (544). Further, the machine readable ticket may be paper with a bar code (546). Alternatively, the machine readable token is punch card (548). Alternatively, the machine readable ticket may be a card having a magnetic strip (550). Alternatively, the machine readable ticket may be a card smart card (552).

This method may further comprise reading a credit card with the first terminal, and making the removable digital media device available to the user after the second terminal has read the credit card (554).

This method may further comprise accepting a payment from the user (556). Further, accepting a payment from the user may include reading a credit card with the first terminal (558). Alternatively, accepting a payment from the user may include providing access to an electronic payment service via the first terminal (560). Alternatively, accepting a payment from the user may include accepting currency (562). Alternatively, accepting a payment from the user may include accepting a card having a first information stored thereon relating to the available credit the user, reading the first information, and writing a second information to the card (564).

With reference to the FIGS. 7 to 10, one embodiment of the present invention comprises a digital media vending device 910 that has a data storage device for digitally storing a plurality of data or data file selections. Data storage device is central processing unit, or CPU 920, which includes a hard drive 922, for storing music selections, advertising information, musician information and other pertinent files used with the vending device 910. All data and information are preferably in a digitally readable format. One preferred format is a compressed file format, such as MP3 (MPEG-1 Audio Layer-3). Audio may be stored as *.wav files, images may be stored as *.jpg files and band/song descriptions are stored as *.txt files on the CPU's hard drive. A source supply of target media blanks, or compact discs 930, with a printable media cover is also provided inside device 910.

In one configuration, device 910 is compartmentalized and has a width of between about 18 and 24 inches, a height of between about 28 and 34 inches and a depth of between about 10 and 16 inches. Vending device 910 only requires an external power source 924. The power source required is 120 VAC. Screen display 926 may be a LCD type with touch interface allowing consumers to make music selections and providing a “computer-like” functionality. All consumer actions take place through the touch screen interface 926. The LCD display is driven by CPU.

The CPU is configured to include previewing processor means for accessing the data selections and displaying them in an audiovisual format on screen display 926 prior to ordering chosen data selections. The CPU communicates with an encoding means 940 for replicating chosen data selections from the data storage device onto a CD 930. Preferably, the CPU operating system is WINDOWS® 2000. There is a processing means with file conversion means for converting, compressing and/or decompressing files for ordering the chosen data selections and transferring them from the data storage device to CD recording device 940. The CD's are moved within device 910 by mechanical means, such as robotic arms 932, a push mechanism or the like.

Device 910 includes at least one external port 990 for downloading the chosen data selections from the data storage device to a consumer recording device, such as an MP3 player. Additionally, in one embodiment, a pair of audio speakers 9140 are connected to stereo audio output port of the CPU. Preferably, device 910 is connected to a communications network so that authorized persons may access the CPU remotely for maintaining the system. Device 910 also has a cash/credit/payment means 9170 for facilitating the purchase of custom CD's, advertising, information and so forth.

The network for connecting the device(s) to a client system and the Internet includes a high-speed wireless modem 9110, which may be a cable modem, satellite modem or wireless modem. The media vending device 910 is configured for constant communication with Internet website 9120. Receiver 9130 communicates with the central processing unit 920 to receive music, which plays through digital speakers 9140 or wireless transmitter 9150. With a wireless receiver, shops, stores and facilities that house device 910 may exploit wireless transmitter means 9150 permitting music to play through the facility's sound system 9160.

The custom manufacture of a CD employing device 910 will now be described. With reference to FIGS. 8-10, cash/purchase/credit machine 9170 facilitates use of most types of currency for purchasing CD's. Payment is made by depositing $1, $5 and/or $10 bill(s) into, a bank note validator/acceptor 9170, as shown in FIG. 10. The validator is connected to a serial port of CPU by way of SIA 9171. With reference to the Figures, via touch screen 926, a consumer inputs information corresponding to data selections. Abbreviated “clips” may be heard through digital speakers 9140 and images viewed on display 926 while creating a compact disc. Once music selections are chosen, robotic transfer arm 932 transfers a CD from the supply of blanks and moves it to high speed CD burner 940. The CD burner communicates with the central processing unit, and the files are encoded onto the CD in a digitally readable format. Next, robotic arm 942 moves the CD from the burner to the printer 950. Printer 950 is an inkjet printer that prints directly onto the CD or a laser-edging tricolor printer. The CD printer dispenses the finished CD to the consumer through slot 960.

The consumer may also purchase a CD casing from casing supply 970 for encasing his/her CD. After payment, robotic push mechanism 972 pushes an empty CD casing 970 through the discharge slot 980 to consumer.

One embodiment of the vending device includes an external compression file upload plug-in 990. After a consumer selects and purchases a set of music, he/she may upload the selections to a consumer recording device 9100 such as an MP3 player instead of encoding to a compact disc.

According to the system, data selections are previewed, chosen and copied on a target media by customers, and each of the vending devices has a display 926 for displaying images. The present invention also, however, contemplates a method that builds upon a data vending method adapted to a system that includes a host computer for storing a plurality of data files and a plurality of remote digital media vending devices connected with the host computer by way of a communications network.

In that embodiment, the system includes steps for (i) providing advertising rules to advertisers by way of the network, (ii) providing payment means for the advertisers to purchase display space on a site-specific vending device, (iii) uploading an advertiser image to the host computer and (iv) facilitating the display of the advertiser image for a time period on a site-specific device. Preferably, the computer is configured to calculate a royalty sum corresponding to each of the chosen selections. More preferably, the system includes a step for electronically depositing the royalty sum into an artists account via the network.

In another embodiment, the data vending method includes steps for (i) compiling information corresponding to the number of chosen selections (ii) ranking the selections based upon the number of selections copied and (iii) reporting the rankings to users over the network.

The Website navigation and functionality for the vending device 910 employing these embodiments will now be described. The Website 9120 includes Advertising Link 9200 and Digest Link 9202. The Advertising Link 9200 includes navigation buttons for completing the advertising offerings for advertisers. There is a first step for providing advertising rules 9205 to advertisers. There is a second step for providing payment means for the advertiser's purchased display space on a site-specific vending device 910. Advertisers may select the state 9204, city 9206 and facility, shop, store or facility 9208 corresponding to the location of the particular device 910 on which the advertiser would like his message to be displayed. The advertiser makes payment 9210 and uploads his advertisement 9212 to the CPU where it is stored. An advertisement may include a digital picture, or a simple animation to be run on the display screen of the vending device 910 when the unit is not in use. The central processing unit is configured for facilitating the display of the advertiser image for time period on the corresponding vending device 910.

The Website 9120 also includes a Digest Link 9213, which facilitates a digital (and hard copy) publication automatically reported to users by way of e-mail. Information corresponding to the number and type of music selections is stored in the CPU. The CPU is configured to constantly process and compile information corresponding to the number and type of chosen selections, rank the selections based upon the number chosen or downloaded and report the rankings to users over the network. This information is compiled to define a national top artist 9203, a regional and state top artist 9207 and a location artist by city 9209. The media vending device 910 may be remotely accessed by authorized employees from the homepage link 9310 for monitoring and maintenance. Royalty payments may be sent electronically to the artist using the network.

In another embodiment, a data file vending method adapted to a system including a host computer for storing a plurality of data files and a plurality of remote kiosks connected with the host computer via a communication network, wherein data files are previewed, selected, and copied on a target media by users, and wherein each of the kiosks has a display for displaying images, the data file vending method, comprises: a first step for providing advertising rules to advertisers by way of the network; a second step for providing payment means for the advertisers to purchase display space on a site-specific kiosk; a third step for uploading an advertiser image to the host computer; and a fourth step for facilitating the display of said advertiser image for a time period on said site-specific kiosk.

In another embodiment, a data vending method adapted to a system including a host computer for storing a plurality of data files and a plurality of remote digital media vending devices connected with the host computer via a communication network, wherein data selections are previewed, chosen and copied on a target media by customers, the data vending method, comprises: a first step for compiling information corresponding to the number of chosen selections; a second step for ranking the selections based upon the number copied; and a third step for reporting the rankings to users over the network. In this method, the computer may be configured to calculate a royalty sum corresponding to each of said chosen selections, wherein said system further comprises a step for electronically depositing said royalty sum into a predetermined account.

Although this invention has been described and illustrated in detail with reference to certain illustrative embodiments, variations and modifications exist within the scope and spirit of the invention as described and defined in the following claims:

1. A digital file vending device comprising:
a data file storage device for digitally storing a plurality of data files;
a supply of media;
means for accessing said plurality of data files and displaying said plurality of data files prior to ordering chosen data selections;
means for replicating said chosen data files from said data file storage device on a medium from the supply;
means for ordering said chosen data files and transferring said chosen data files from said data file storage device to said means for replicating;
at least one external port for downloading said chosen data files from said data storage device to a consumer recording device; and
network means for connecting said data storage device to at least one client system.

2. A method for producing a customized removable consumer digital medium, the method comprising the steps of:
Reading a set of input parameters via a digital input device on a first terminal;
Determining, based on the set of input parameters, a set of files to include on a digital medium;
Transmitting a message indicating the set of files from the first terminal to a second terminal via a network;
Receiving the message with the second terminal;
Reading the set of files from a mass storage device using the second terminal;
Writing the set of files to the removable digital medium using the second terminal;
Making the removable digital medium available to a user.

3. The method of claim 2, wherein reading a set of input parameters includes displaying options on a touch sensitive video display and reading the input parameters from the touch sensitive video display.

4. The method of claim 2, wherein reading a set of input parameters includes displaying options on a video display and reading the input parameters from a pointer device.

5. The method of claim 2, wherein reading a set of input parameters includes displaying options on a video display and reading the input parameters from a keypad.

6. The method of claim 2, wherein reading a set of input parameters includes displaying options on a video display and reading the input parameters from a keyboard.

7. The method of claim 2, further comprising providing a graphical database interface via a video display on the first terminal.

8. The method of claim 7, wherein providing the graphical database interface includes storing a database on the first terminal.

9. The method of claim 7, wherein providing the graphical database interface includes storing a database on the second terminal.

10. The method of claim 7, wherein providing the graphical database interface includes storing a database on a remote terminal.

11. The method of claim 7, wherein providing the graphical database interface includes presenting an option to search by artist, album, and track.

12. The method of claim 7, wherein providing the graphical database interface includes displaying an image of an album and a list of tracks on the album.

13. The method of claim 2, wherein transmitting the message includes transmitting the message over a local area network coupled between the first terminal and the second terminal.

14. The method of claim 12, wherein transmitting the message over the local area network includes transmitting the message over a wireless local area network.

15. The method of claim 2, wherein reading the set of files from a mass storage device includes reading the set of files from a hard disk drive internal to the second terminal.

16. The method of claim 2, wherein reading the set of files from a mass storage device includes reading the set of files from a hard disk connected external to the second terminal.

17. The method of claim 2, further comprising generating a machine readable token with the first terminal, making the machine readable token available to the user, and making the removable digital media device available to the user after the second terminal has read the machine readable token.

18. The method of claim 17, wherein the machine readable token is a paper with a bar code.

19. The method of claim 17, wherein the machine readable token is punch card.

20. The method of claim 17, wherein the machine readable token is card having a magnetic strip.

21. The method of claim 17, wherein the machine readable token is card smart card.

22. The method of claim 2, further comprising reading a credit card with the first terminal, and making the removable digital media device available to the user after the second terminal has read the credit card.

23. The method of claim 2, further comprising accepting a payment from the user.

24. The method of claim 23, wherein accepting a payment from the user includes reading a credit card with the first terminal.

25. The method of claim 23, wherein accepting a payment from the user includes providing access to an electronic payment service via the first terminal.

26. The method of claim 23, wherein accepting a payment from the user includes accepting currency.

27. The method of claim 23, wherein accepting a payment from the user includes accepting a card having a first information stored thereon relating to the available credit the user, reading the first information, and writing a second information to the card.

28. A data file management and vending system comprising:
a plurality of kiosks configured to permit a user to make a data file selection from a collection of such data files and pay for the data file selection;
a network operations center including a storage system for storing the collection and at least one server for processing requests for data files and communicating data files to kiosks;
a management system comprising at least a kiosk management system configured to control the flow of data files and to collect information concerning the data files selected;
wherein each of the plurality of kiosks includes a user interface device, a central processing unit, storage, means for transferring the selected data files onto a medium;
wherein a network interconnects through links the network operations center, the kiosks, and the management system.

29. The data file management and vending system of claim 28, wherein at least one kiosk includes a plurality of user interface devices and a plurality of payment receivers coupled to the central processing unit so that a plurality of users can make different data file selections, and pay for the user's selections.

30. The data file management and vending system of claim 29, wherein the at least one kiosk includes a burning station coupled to the network, and spaced apart from at least one of the payment receivers and at least one of the user interface devices, the burning station configured to receive a ticket from a user to identify the user's data file selection and transfer the data files.

31. The data file management and vending system of claim 28, wherein the user interface device is a touchscreen that displays information to the user and receives inputs from the user.

32. The data file management and vending system of claim 28, wherein the means for transferring the selected data files onto a medium includes a compact disc burner.

33. The data file management and vending system of claim 32, wherein the means for transferring the selected data files onto a medium includes a port configured to permit attachment of a user's recordable medium and to permit transfer therethrough of the selected data files to the medium.

34. The data file management and vending system of claim 28, wherein the data files are stored on the storage of each kiosk, and one of the central processing unit or the network operations center or the management system includes instructions to retain only the most frequently selected data files based on a predetermined criteria, and if a data file meets the criteria, the data file is retained in the storage, and if a data file does not meet the criteria the data file is removed from storage.

35. The data file management and vending system of claim 34, wherein the instructions to retain only the most frequently selected data files based on a predetermined criteria include information concerning the frequency of selection of data files for each kiosk independently, such information forms the criteria for that kiosk, and if a data file does not meet the criteria for that kiosk the data file is removed from storage.
